(19) United States
(12) Patent Application Publication
(10) Pub. No.: US 2023/0095924 A1
(43) Pub. Date: Mar. 30, 2023

(54) COVERS FOR VEHICLES

(71) Applicant: Robert REID, Laneview, VA (US)

(72) Inventor: Robert REID, Laneview, VA (US)

(21) Appl. No.: 17/956,103

(22) Filed: Sep. 29, 2022

Related U.S. Application Data
(60) Provisional application No. 63/249,905, filed on Sep. 29, 2021.

(51) Int. Cl. B60J 11/04

(52) U.S. Cl. CPC B60J 11/04

(57) ABSTRACT

A cover for a car includes a cloth or clothlike cover base, a tinted aluminum coating disposed on an outer surface of the cloth or clothlike cover base; and one or more security flaps connected to an inner surface of the cloth or clothlike cover base at a position that enables the one or more security flaps to be inserted into one or more of the car's doors.

### RELATED APPLICATION

The present application claims priority from U.S. Provisional Application No. 63/249,905, entitled “Covers For Vehicles”, to Robert Reid, filed on Sep. 29, 2021, the disclosure of which is incorporated here by reference.

### TECHNICAL FIELD

The present invention generally relates to covers for vehicles and, more particularly, to covers that are intended to reduce the heat inside vehicles associated with sunlight.

### BACKGROUND

Automobile covers are currently used to protect vehicles from rain, sleet, snow, and other weather-related events, as well as to prevent scratches or debris (e.g., tree sap, tree leaves, dust, etc.) from falling onto the vehicle.

Some automobile covers are currently used to prevent the inside of a vehicle from becoming excessively hot, especially when the vehicle is exposed to direct sunlight or the vehicle is parked in an area subject to high temperatures. Even if the outside temperature is only 75 degrees Fahrenheit, the interior temperature of a parked vehicle can rapidly climb to excessive and unbearable temperatures. This rise in temperature can cause an occupant entering the vehicle to be exposed to extremely high surface temperatures on the vehicle's seats, the steering wheel, the seat belts, baby/child car seats, and other components in the vehicle. In addition, the entering occupant will experience a high air temperature in the vehicle, which in addition to being uncomfortable for the occupant, may cause health-related emergencies or issues, especially in someone who already has a health history of asthma, COPD, heat stroke, etc.

One example of an automobile cover is described in U.S. Pat. No. 6,779,827 (“the 827 patent”). As shown in FIGS. 6 and 7, and discussed in the '827 patent, the automobile cover requires trunk cords, hood cords, and a trunk anchor 135, which is placed in the inside of the trunk. In addition, a winder 300, as shown in FIG. 4, is used to unroll and roll up the cover apparatus. Further, FIG. 10 and the '827 patent describe that the sides of the vehicle cover may be closed inside the door so that the cover can be securely attached.

Unfortunately, while the '827 patent attempts to solve the problem of keeping cars in the sunlight cool, it has certain problems. For example, the automobile cover disclosed in the '827 patent is comprised of several parts and cords, as well as a bulky holder used to unroll and roll up the cover apparatus. Thus, the cover apparatus is not necessarily lightweight and requires a user of the apparatus to attach multiple cords to various parts of the vehicle, which can cause frustration when the user is trying to put the cover over the vehicle. Further, the user takes the chance that the apparatus used to unroll and roll up the cover can accidentally dent or scratch the vehicle or inadvertently damage a window. A user may not be tall enough to unroll/roll up the cover using the cover apparatus holder. In addition, although the '827 patent discloses that the cover can be closed inside of the vehicle doors to secure the cover, this does not necessarily allow for the vehicle cover to adequately reflect the light and cool down the vehicle since part of the cover is now inside of the car and the sun is hitting the metal doors.

Accordingly, it would be desirable to provide a cool cover for vehicles that overcomes the afore-described drawbacks.

### SUMMARY

A cover for a car includes a cloth or clothlike cover base, a tinted aluminum coating disposed on an outer surface of the cloth or clothlike cover base; and one or more security flaps connected to an inner surface of the cloth or clothlike cover base at a position that enables the one or more security flaps to be inserted into one or more of the car's doors.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows an isometric view of the cooling cover on a vehicle;

FIGS. 2 and 3 show side views of the cooling cover on a vehicle;

FIG. 4A illustrates a bottom view of the cooling cover stretched out flat;

FIG. 4B shows an enlarged, side view of the cooling cover including a tinted aluminum outer surface, a water-resistant inner surface and a security flap; and

FIG. 5 shows an enlarged view of a security flap of the cooling cover according to an embodiment.

### DETAILED DESCRIPTION

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As described in the Background section, there are problems associated with the available covers for vehicles which attempt to keep vehicles (cars, trucks, etc.) cool when they are being radiated by the sun. Embodiments described herein address these problems by, for example, using security flaps, an apparatus that is easy to use, and which consistently cools down the inside of a vehicle.

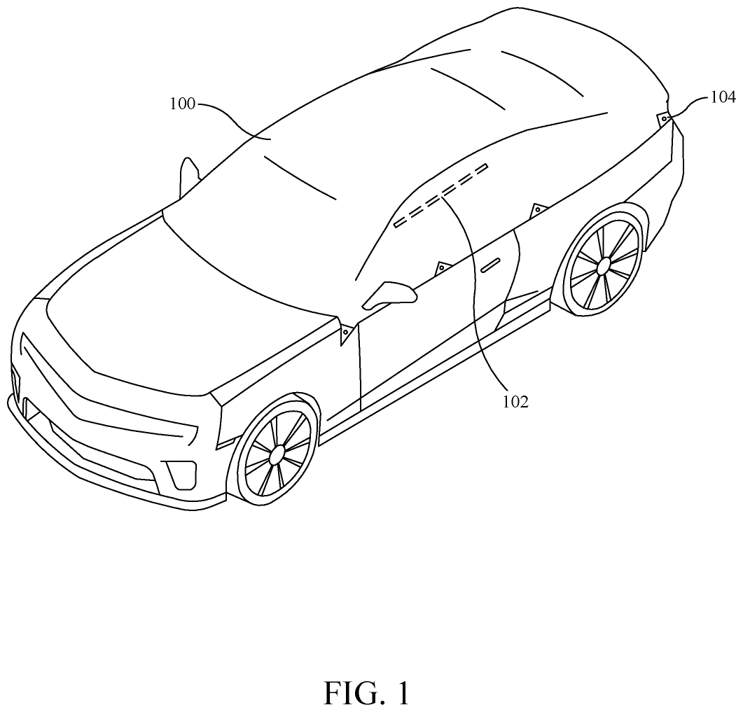

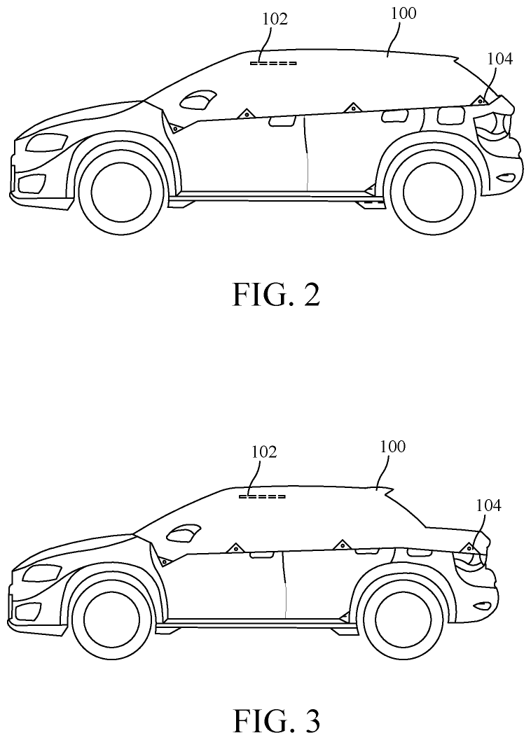

An isometric view of the reflective cooling cover 100 is shown in FIG. 1, while two side views are provided in FIGS. 2 and 3. Referring now to the side view of the different layers of the cooling cover 100 shown in FIG. 6, the apparatus for cooling a vehicle 100 is comprised of cloth or clothlike material 602, where one surface 604 of the cloth or clothlike material 602 is coated light blue and the other surface 606 is coated with a tinted aluminum coating, which is used to reflect the heat. However, apparatus 100 can be made of any suitable material and coated with any type of material which can reflect heat. According to one embodiment, the surface 604 of cover 100 which includes the light blue coating is water resistant, which allows the cooling cover 100 to breathe but also reflects the heat away from the vehicle. Note that surface 604 and cover base 602 can be made of the same material such that the embodiment of FIG. 6 could be illustrated with just layers 606 and 602.

The tinting of the aluminum coating 606 is designed to reduce the glare but not the heat reflective ability. The reason for this tinting is twofold: (1) to avoid blinding humans on the ground when passing a vehicle covered with the apparatus, and (2) to avoid blinding pilots of planes flying over an area where one or more vehicles might be parked and the reflection might absent the tinting, otherwise cause a blinding glare.

According to one embodiment, the tinted aluminum side 606 of the cooling cover 100 can reflect approximately 90% (e.g., 85%-95%) of the heat radiation which impacts the cover 100, while allowing approximately 10% (e.g., 5%-15%) of the heat radiation to pass through. This design feature of the cooling cover 100 enables a limited amount of heat radiation to pass through the cover to evaporate any moisture which might become trapped under the cover to avoid, e.g., damage to the finish, while at the same time minimizing interior heating of the vehicle.

Referring again to FIGS. 1-3, the cover apparatus 100 may include two permanently attached cords (not shown) on the driver's side, that may be tied to the bumper or wheels and to the reinforced eyelets 104 to keep the cover tight to the vehicle. There are also two permanently attached cords (not shown) on the opposite side of the cover allowing it to be pulled over the vehicle and attached in a similar fashion to the passenger side of the vehicle. There are additional grommets or eyelets 104 sewn into the cover 100 with a soft backing added to protect the surface of the vehicle. These additional grommets 104 are for the purpose of allowing additional cords to attach to the vehicle if the cover 100 is intended to be on the vehicle for a lengthy period of time. In addition, there is a center grommet for a cord and lock to prevent theft of the cover. There can be additional grommets, as needed, to allow for the cords to lock the cover 100 to the vehicle. There can also be tie-downs or ropes used to allow for easy covering of a vehicle.

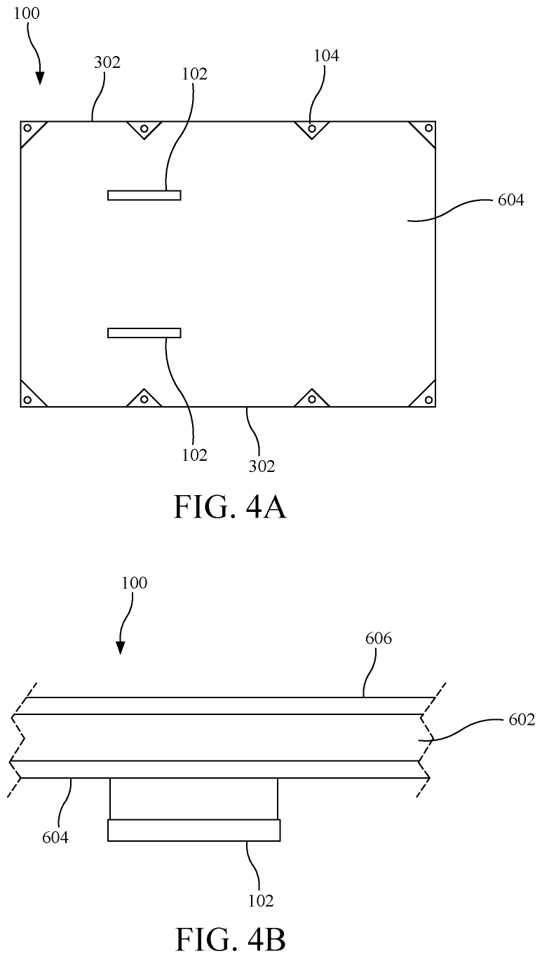

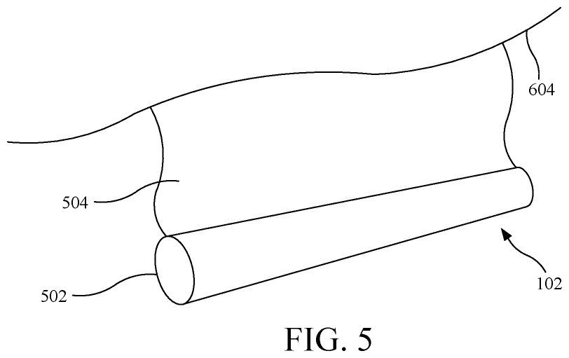

Referring now to FIGS. 4A, 4B, and 5, the cover apparatus 100 comprises at least one security flap 102 but can comprise several more, where each security flap 102 fits inside the door of the vehicle. Note that the security flap(s) 102 are separate pieces of material that are sewn or otherwise attached to surface 604 (i.e., the surface which does not have the tinted aluminum coating 606) so that the flaps 102 can be closed inside the door of the vehicle while the portion of the cover 100 which covers the window above the door (and possibly the door itself if the cover extends to the bottom of the vehicle) remains in a position to fully reflect heat from the intended exterior surfaces.

Using the security flaps 102, apparatus 100 is securely attached to the vehicle preventing theft and is attached to the cover 100 such that the cover apparatus 100 still covers the outside of the vehicle. The security flap(s) 102 are designed to be one piece that partially goes inside the doors of the vehicle and has an element 502 at the bottom of security flap 102. Element 502, when positioned with the rest of the security flap 102 inside the door is too large to be pulled out of the car, and can be a rod or tube which is attached to or sewn into the security flap(s). Multiple security flaps 102 can be sewn to the cover 100 such that for a two-door or four-door car, there are either two or four flaps, respectively. The security flaps serve an anti-theft objective as a first purpose and further anchor the cover 100 to the vehicle as a second purpose. Multiple items/materials may be used to enlarge, thicken, or pad the security flap as element 502 to prevent it from being pulled out of the vehicle door. The two-inch wide area at the top of the security flap 102 gives it the strength to last indefinitely. The balance of flap 102 covers the sides of the vehicle from sunlight all the way down to the area just below the door handles, and the outwardly facing surface 504 thereof can also be coated with aluminum thus adding to the heat reflecting coverage well below any area that needs ultraviolet rays blocked from the interior.

According to one embodiment, as best seen in FIG. 4A, when the cover 100 covers the top of the car and the windows, the security flaps 102 are connected to the inner surface of the cloth or clothlike cover base 602 at a distance from a side edge 302 of the cover base which is substantially similar to the distance from a top of the car's window to a top of the car's door handle.

It should be noted that a side benefit of this cover and design is that it reduces dramatically the carcinogens released in the interior of the vehicle by the intense heat developed by the high temperatures within the vehicle. The newer the car the more likely the plastics, vinyl, and other synthetic materials will heat up and release these toxins into the car's interior.

There can be as many as eight pouches for magnets to be placed in them for further bonding to the vehicle. The magnets may be sewn into the apparatus' pouches or a user can insert magnets into the pouches. A user of the apparatus could use either the magnets or the cords, or both, to attach the cover apparatus to the vehicle.

In some cases, there can be additional parts of the cover, which can be unfolded and used to completely cover the entire sides of the vehicle so that there is an additional reduction of sunlight on the sides of the vehicle.

In one test, the inventor determined that an uncovered vehicle sitting in the sun measured an internal cabin temperature at the location of the dashboard of 146 degrees Fahrenheit, but after the vehicle was covered with the apparatus, the temperature went down to 106 degrees Fahrenheit. The cool cover was on the vehicle from 12:45 PM until 2:25 PM with the ambient temperature hovering between 95 and 100 degrees and never in the shade. It was exposed to direct sunlight throughout the duration of this test.

The cover for cooling a vehicle is designed to be lightweight and weighs less than 10 pounds. The cover can be folded up and thrown in the back seat, for example. The cover could also include Velcro® straps which would allow for the cover to be rolled up and attached such that it would not unroll. The cover could also include attached straps for ease of folding up the cover. The cover apparatus for covering a vehicle can, for example, be manufactured in three sizes: 8.5′×12′, 8.5′×16′, and 8.5′×20′, but can according to other embodiments be manufactured in any shape or size. The apparatus can be used to cover any size vehicle, such as a truck, car, van, SUV, motorcycle, motorhome, or cab of a tractor-trailer. In addition, the cover apparatus could be used to cover a boat, a plane, a semi-trailer, or a refrigerated trailer. In some sizes of the apparatus, the cover can be draped over the vehicle, where the entire vehicle is covered, or, according to some embodiments, can cover just the vehicle's roof and windows.

This cover is designed to be used as a survival blanket if needed. With a waterproof or water-resistant coating, it can withstand wind, rain, cold, or snow, and even keep an occupant dry. Further, the aluminum coating can reflect a human's body heat keeping them warm. In addition, the cover can be made into a tent or wrapped around the individual or individuals for retention of their body heat, reflecting inward 90% of the body heat. Also, the light blue waterproof or water-resistant coating withstands rain, wind, cold, and snow.

Using this in a colder environment as a survival blanket will cause 90% of one or more people's body heat to be forced inward keeping them warm until help arrives. In addition, the bright light blue will be distinctively visible from above or from a distance on the ground. If a user is in a hotter zone, such as the desert, it can be used as a cover for your vehicle during the day to keep it cool either staying in the vehicle or by setting it up as a tent and at night by wrapping it around one or more people and retaining their body heat.

It should be understood that this description is not intended to limit the invention. On the contrary, the exemplary embodiments are intended to cover alternatives, modifications, and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed:

1. A cover for a car comprising:
a cloth or clothlike cover base;
a tinted aluminum coating disposed on an outer surface of the cloth or clothlike cover base; and
one or more security flaps connected to an inner surface of the cloth or clothlike cover base at a position that enables the one or more security flaps to be inserted into one or more of the car's doors.

2. The cover of claim 1, wherein the tinted aluminum coating reflects 85%-95% of heat radiation which impacts the tinted aluminum coating while allowing 15%-5% of the heat radiation to pass through.

3. The cover of claim 1, wherein the one or more security flaps are connected to the inner surface of the cloth or clothlike cover base at a distance from a side edge of the cover base which is substantially similar to the distance from a top of the car's window to a top of the car's door handle.

4. The cover of claim 1, wherein the one or more security flaps include an element disposed at a bottom portion thereof which is thicker than the one or more security flaps to prevent the security flaps from being pulled through the car's window.

5. The cover of claim 1, wherein a tint used in the tinted aluminum coating reduces glare.

6. A cover for a car comprising:
a cloth or clothlike cover base;
a tinted aluminum coating disposed on an outer surface of the cloth or clothlike cover base; and
one or more security flaps connected to an inner surface of the cloth or clothlike cover base at a position that enables the one or more security flaps to be inserted into one or more of the car's doors;
wherein the tinted aluminum coating reflects 85%-95% of heat radiation which impacts the tinted aluminum coating while allowing 15%-5% of the heat radiation to pass through;
wherein the one or more security flaps are connected to the inner surface of the cloth or clothlike cover base at a distance from a side edge of the cover base which is substantially similar to the distance from a top of the car's window to a top of the car's door handle;
wherein the one or more security flaps include an element disposed at a bottom portion thereof which is thicker than the one or more security flaps to prevent the security flaps from being pulled through the car's window;
wherein a tint used in the tinted aluminum coating reduces glare.
